(19) United States
(12) Patent Application Publication
(10) Pub. No.: US 2026/0321271 A1
(43) Pub. Date: Oct. 15, 2026

(54) NONLINEAR POST-PROCESSING WITH NOISE REFINEMENT FOR ENHANCED NOISE REDUCTION AND ECHO CANCELLATION

(71) Applicant: Synaptics Incorporated, San Jose, CA (US)

(72) Inventors: Saeed Mosayyebpour Kaskari, Irvine, CA (US); Alireza Masnadi-Shirazi, Irvine, CA (US)

(73) Assignee: Synaptics Incorporated, San Jose, CA (US)

(21) Appl. No.: 19/174,708

(22) Filed: Apr. 9, 2025

(51) Int. Cl. G10L 21/0208

(52) U.S. Cl. CPC G10L 21/0208; G10L 2021/02082

(57) ABSTRACT

A method, device, and system for audio signal processing is related to nonlinear post-processing filter to enhance the suppression of interference in audio signals. A nonlinear post filter suppresses residual interference, e.g., noise or echoes, in a target signal produced by a linear filter based on the target signal, which includes the residual interference, and a noise signal that represents the interference that was removed from the raw microphone audio signal by the linear filter. The nonlinear post filter refines the noise signal by scaling the noise signal when no speech is detected and removing residual speech in the scaled noise signal when speech is detected. A gain filter to suppress residual interference in the target signal is generated using the refined noise signal and the target signal, and is applied to the target signal to produced an enhanced audio signal with residual interference suppressed.

### TECHNICAL FIELD

The present implementations relate generally to audio signal processing, and specifically to techniques for noise reduction and echo cancellation.

### BACKGROUND OF RELATED ART

Many communication devices include microphones configured to convert sound waves into audio signals that can be transmitted, over a communications channel, to a receiving device. The audio signals often include a speech component (such as from a user of the communication device) and a noise component (such as from a reverberant enclosure). Signal processing techniques are often used for speech enhancement to suppress the noise component of the received audio signals without distorting the speech component.

Adaptive linear filtering techniques, such as beamforming and linear echo cancellation, are effective in reducing unwanted interference in noisy environments. Beamforming, for example, focuses on spatial filtering by enhancing signals from desired directions while suppressing noise from other directions, while echo cancellation reduces echo or playback signal. Linear filtering techniques, such as beamforming and echo cancellation, however, often leave residual interference, e.g., noise or echo, in the output signal due to the limitations of the linear models in handling real-world signals, which can contain nonlinear distortions, unpredictable noise patterns, and complex environmental dynamics. Thus, there is a need to suppress residual interference, e.g., noise or echo, from the output signals from linear filter systems.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method for enhanced interference reduction in an audio signal. The method includes receiving at least one audio signal from a microphone and linearly filtering the at least one audio signal to reduce interference comprising at least one of noise or echo in the audio signal and to produce a target signal that includes residual interference and a noise signal that comprises the interference removed from the at least one audio signal. The method further includes nonlinearly post filtering the target signal to suppress the residual interference in the target signal. Nonlinearly post filtering the target signal includes scaling the noise signal based on the target signal and the noise signal when no speech is detected in the target signal; removing residual speech from a scaled noise signal based on the scaled noise signal and the target signal when speech is detected in the target signal; generating a gain filter based on the target signal and the scaled noise signal with the residual speech removed; and applying the gain filter to the target signal to generate an enhanced audio signal with the residual interference suppressed.

Another innovative aspect of the subject matter of this disclosure can be implemented in an audio enhancement system configured for enhancing interference reduction in an audio signal, that includes a processing system and a memory. The memory stores instructions that, when executed by the processing system, cause the audio enhancement system to receive at least one audio signal from a microphone and to linearly filter the at least one audio signal to reduce interference comprising at least one of noise or echo in the audio signal and to produce a target signal that includes residual interference and a noise signal that comprises the interference removed from the at least one audio signal. The audio enhancement system is further caused to nonlinearly post filter the target signal to suppress the residual interference in the target signal. The audio enhancement system is configured to nonlinearly post filter the target signal by being configured to scale the noise signal based on the target signal and the noise signal when no speech is detected in the target signal; remove residual speech from a scaled noise signal based on the scaled noise signal and the target signal when speech is detected in the target signal; generate a gain filter based on the target signal and the scaled noise signal with the residual speech removed; and apply the gain filter to the target signal to generate an enhanced audio signal with the residual interference suppressed.

### BRIEF DESCRIPTION OF THE DRAWINGS

The present implementations are illustrated by way of example and are not intended to be limited by the figures of the accompanying drawings.

FIG. 1 shows an example audio receiver that is configured for suppression of interference, e.g., noise or echo, in an audio signal.

FIG. 2 a block diagram of an example linear filter with a noise signal generator, according to some implementations.

FIG. 3 shows a block diagram of an example nonlinear post filter configured to suppress residual interference in a target signal, according to some implementations.

FIG. 4 shows a block diagram of an example of a noise signal scaler that may be included in the nonlinear post filter to refine the noise signal, according to some implementations.

FIG. 5 shows a block diagram of an example noise floor remover that may be included in the nonlinear post filter, according to some implementations.

FIG. 6 shows a block diagram of an example residual speech remover that may be included in the nonlinear post filter to refine the noise signal, according to some implementations.

FIG. 7 shows a block diagram of an example gain filter component that may be included in the nonlinear post filter, according to some implementations.

FIG. 8 shows a block diagram of an example audio enhancement system, according to some implementations.

FIG. 9 shows an illustrative flowchart depicting an example operation for audio interference reduction, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As discussed above, adaptive linear filtering techniques, such as beamforming and linear echo cancellation, are signal processing techniques used to suppress the interference component of received audio signals, e.g., noise or echo, without distorting a speech component of the audio signals. Beamforming, for example, spatially filters the audio signal by enhancing the signal from desired directions, while suppressing signals from other directions, thereby suppressing interference from these other directions. Echo cancellation suppresses echo or the playback signal captured by the speaker's microphone, thereby preventing the speaker from inadvertently hearing their own voice. Linear filtering methods, however, are unable completely filter real-world signals, which often contain nonlinear distortions, unpredictable noise patterns, and complex environmental dynamics. Consequently, the output signal produced by linear filters often include residual interference, e.g., noise or echo.

Aspects of the present disclosure recognize the limitations of linear processing systems that result in residual interference in the output signal and uses nonlinear post-processing system and methods to enhance the suppression of interference in the audio signal. A nonlinear post-processing filter suppresses residual interference in the output signal produced by the linear filter using a target signal that contains the desired speech and the residual interference, and a secondary signal, which is sometimes referred to herein as a noise signal, that represents the interference that was removed from the raw microphone input signal by the linear filter. The nonlinear post-processing filter, for example, may use the target signal and the noise signal to generate a gain filter that may be applied to the target signal to suppress the residual interference. The gain filter may be generated using spectral subtraction of the noise signal from the target signal after scaling the noise signal and removing any residual speech from the noise signal. The nonlinear post-processing filter, for example, scales the noise signal, e.g., to minimize a difference between the target signal and the scaled noise signal when there is no speech in the target signal. Any residual speech in the scaled noise signal is removed, e.g., by minimizing a difference between the scaled noise signal and a scaled target signal when there is speech in the target signal and determining a difference between the scaled target signal and the scaled noise signal. The gain filter may then be determined based on the target signal and the scaled noise signal with the residual speech moved. The gain filter may then be applied to the target signal to suppress the residual interference thereby enhancing the overall performance of the linear processing system.

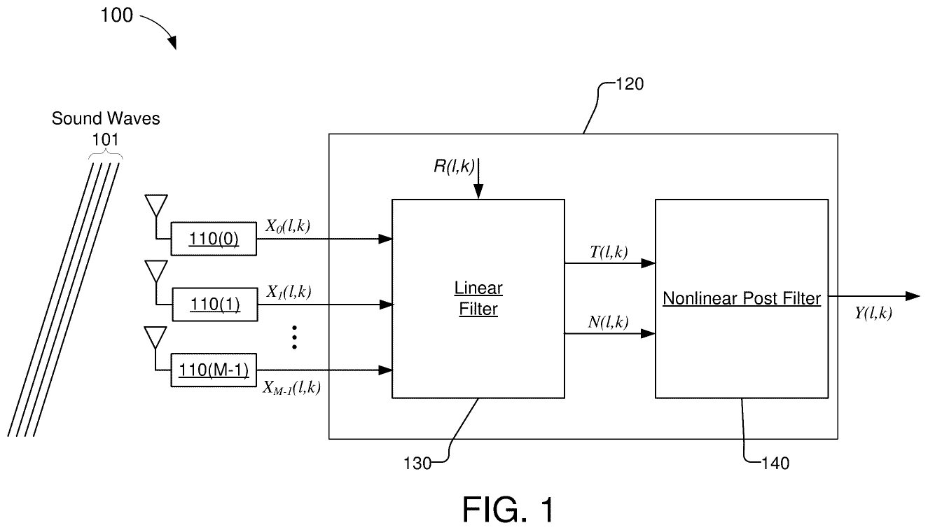

FIG. 1 shows an example audio receiver 100 that is configured for suppression of interference, e.g., noise or echo, in an audio signal, as discussed herein. Audio receiver 100, for example, may be included in any application in which noise suppression in the audio signal is desired, including, but not limited to a headset, helmet, True Wireless Stereo (TWS) earbuds or headphones, tablet, speakerphone, monitor, television, etc.

The audio receiver 100 includes one or more microphones, illustrated as a number (M) of microphones 110(0), 110(1), . . . 110(M−1) arranged in a microphone array and a processing system 120. It should be understood that the audio receiver 100 may include any number (M≥1) of microphones. In some implementations, the audio receiver 100 may additionally include one or more auxiliary microphones, such as a bone conduction microphone (not illustrated).

The microphones 110(0) and 110(1) are configured to convert a series of sound waves 101 (also referred to as “acoustic waves”) into audio signals Xᵢ(l, k), i=0 . . . . M−1, M≥1, where l is a frame index and k is a frequency index associated with a time-frequency domain. The sound waves 101 may include user speech and may be mixed with unwanted interference, such as noise or echo.

The processing system 120 includes a linear filter 130 and a nonlinear post filter 140. The linear filter 130, for example, may include any desired linear filter, such as a spatial filter that performs beamforming, or a linear filter that performs echo cancelation. The linear filter 130 receives the raw microphone audio signals Xᵢ(l, k) and, optionally, a reference playback signal R(l, k) used with echo cancellation in the linear filter 130. The linear filter 130 applies an adaptive linear filter to reduce interference in the audio signals Xᵢ(l, k) and produces a target signal T(l, k) that contains the target speech signal with reduced noise and/or echo. Residual interference, e.g., noise and echoes, typically persists in the target signal T(l, k) produced by the linear filter 130 because linear filter techniques primarily assume linear relationships between the signals and interference. Real-world acoustic environments, however, typically exhibit some nonlinear characteristics, such as reverberation, microphone distortions, or dynamic background noise, which cannot be fully suppressed through linear techniques alone.

The linear filter 130 may additionally produce a noise signal N(k, l) that contains the interference component, e.g., noise or echo, that was removed from the raw audio signals Xᵢ(l, k). The noise signal N(l, k), for example, may be obtained by subtraction of the target signal T(l, k) from the raw primary microphone signal X₀(l, k) as follows.

N(l,k)=X₀(l,k)−T(l,k) (1)

The nonlinear post filter 140 receives the target signal T(l, k) and the noise signal N(l, k) from the linear filter 130. The nonlinear post filter 140 is configured to suppress the residual interference in the target signal T(l, k), particularly residual interference caused by nonlinearities, based on the target signal T(l, k) and the noise signal N(l, k) and produces an enhanced audio signal Y(l, k). The nonlinear post filter 140, for example, may use the target signal T(l, k) and the noise signal N(l, k) to generate, for each frame, a single value gain filter per frequency bin G(l, k) to that further reduces the residual interference, e.g., echo or noise, in the target signal T(l, k). The enhanced audio signal Y(l, k) produced by the nonlinear post filter 140, for example, may be obtained as:

Y(l,k)=T(l,k)G(l,k) (2)

The nonlinear post filter 140, thus, is a second stage filter that enables more accurate noise and echo suppression by modeling complex relationships that the linear filter 130 cannot account for, thereby significantly enhancing the overall signal quality. The nonlinear post filter 140 complements the adaptive linear techniques used by the linear filter 130 by targeting and reducing residual interference in the target signal T(l, k), resulting in a clearer and more refined output signal Y(l, k).

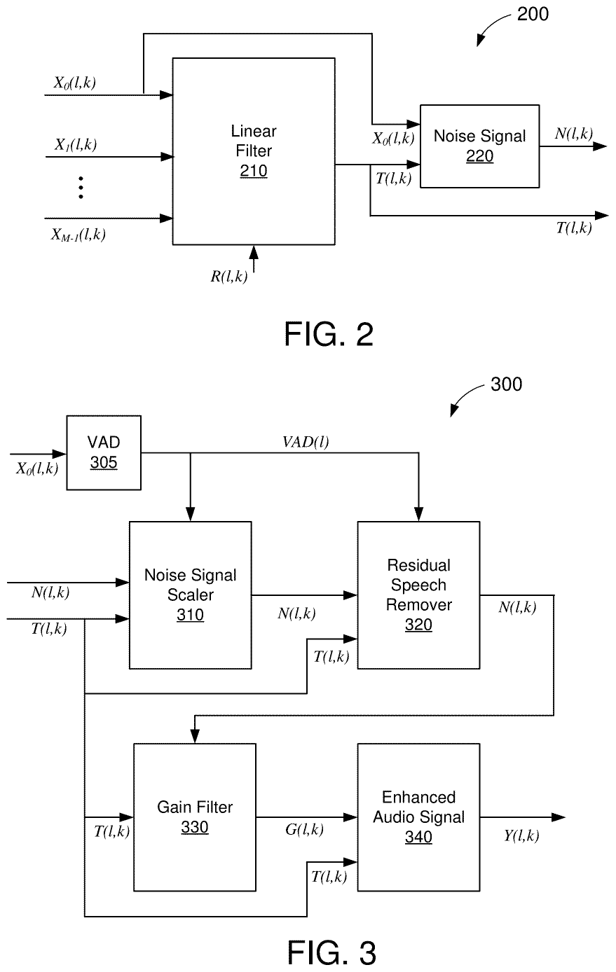

FIG. 2 shows a block diagram of an example linear filter 200 that may be used as the linear filter 130 in FIG. 1, according to some implementations.

The linear filter 200 includes an adaptive linear filter 210 that receives the raw microphone audio signals Xᵢ(l, k) and, optionally, a reference playback signal R(l, k) for echo cancellation. The adaptive linear filter 210 may perform any desired filtering operation on the audio signals to suppress interference, such as noise or echoes. For example, the adaptive linear filter 210 may be perform beamforming to spatially filter the audio signals Xᵢ(l, k) by enhancing the signal from desired directions, while suppressing signals from other directions, thereby suppressing interference from these other directions. In another example, the adaptive linear filter 210 may be perform echo cancellation, e.g., with the assistance of a reference playback signal R(l, k), to suppress echo in the audio signals Xᵢ(l, k). The adaptive linear filter 210 produces a target signal T(l, k) that contains, e.g., a desired speech signal with reduced noise and/or echo. As noted above, linear filtering is unable to completely filter real-world signals, which often contain nonlinear distortions, unpredictable noise patterns, and complex environmental dynamics. Consequently, the target signal T(l, k) often include residual interference, e.g., noise or echoes.

The linear filter 200 is illustrated as further including a noise signal generator 220 that receives the target signal T(l, k) and the raw primary microphone signal X₀(l, k), and produces the noise signal N(l, k). The noise signal N(l, k) contains the interference, e.g., noise or echoes, that are removed from the raw microphone signal X₀(l, k). The noise signal generator 220, for example, may generate the noise signal N(l, k) by subtracting the target signal T(l, k) from the raw primary microphone signal X₀(l, k) as shown in equation 1.

FIG. 3 shows a block diagram of an example nonlinear post filter 300 that may be used as the nonlinear post filter 140 in FIG. 1, according to some implementations. The nonlinear post filter 300 receives the target signal T(l, k) and the noise signal N(l, k) and is configured to suppress the residual interference in the target signal T(l, k) based on the target signal T(l, k) and the noise signal N(l, k) to generate the enhanced audio signal Y(l, k).

The nonlinear post filter 300 for example, may include components used to generate a gain filter G(l, k) that may be applied to the target signal T(l, k) to produce the enhanced audio signal Y(l, k). Before generating the gain filter G(l, k), the noise signal N(l, k) undergoes a refinement process to improve the noise signal N(l, k) so that when the gain filter G(l, k) is determined, speech attenuation in the target signal T(l, k) is minimized, but residual interference is effectively decreased. The refinement process, for example, may scale the noise signal and remove any residual speech content in the scaled noise signal.

In some aspects, the nonlinear post filter 300 may include a noise signal scaler 310 that receives the target signal T(l, k) and the noise signal N(l, k) and refines the noise signal N(l, k) by scaling the noise signal N(l, k) when speech is not detected in the target signal T(l, k), e.g., as determined by a voice activity detector (VAD) 305. The noise signal scaler 310 may scale the noise signal N(l, k) by minimizing a difference between the target signal and a scaled noise signal when speech is not present, e.g., by minimizing an average squared magnitude error.

In some aspects, the nonlinear post filter 300 may include a residual speech remover 320 that receives the target signal T(l, k) and a scaled noise signal N(l, k) from the noise signal scaler 310 and further refines the noise signal by removing any residual speech in the scaled noise signal N(l, k) when speech is detected in the target signal T(l, k), e.g., as determined by the VAD 305. The residual speech remover 320 may remove residual speech in the noise signal N(l, k) by minimizing a difference between the scaled noise signal and the residual speech in the noise signal when speech is present, e.g., by minimizing an average squared magnitude error, and subtracting the residual speech from the scaled noise signal N(l, k).

The noise signal scaler 310 and the residual speech remover 320 receive a speech detection signal VAD(l) from the VAD 305 indicating whether speech is present or not present in the target signal T(l, k). The VAD 305 may be external to or a part of the nonlinear post filter 300. The VAD 305, for example, may be configured to determine or predict whether speech is present (or absent) in the audio signal X₀(l, k). More specifically, the VAD 305 may provide one or more parameters in the speech detection signal VAD(l) indicating whether speech is present or absent in the current frame l of the audio signal X₀(l, k). In some implementations, the VAD 305 may include a deep neural network (DNN) that is trained to infer a probability of speech (p_{speech}(l, k)) or conversely a probability of noise (pₙₒᵢₛₑ(l, k)) in the audio signal X₀(l, k), and the VAD 305 may generate the speech detection signal VAD(l) based on the probability of speech p_{speech}(l, k). For example, the VAD 305 may determine that speech is present in the audio signal X₀(l, k) (VAD(l)=1) if the probability of speech p_{speech}(l, k), averaged across all frequency bins k, is greater than a threshold probability, and otherwise, speech is determined to be not present in the audio signal X₀(l, k) (VAD(l)=0).

In some implementations, the VAD 305 may generate the speech detection signal VAD(l) based on the energy detected in an auxiliary audio signal received via an auxiliary microphone. For example, some auxiliary microphones (such as bone conduction microphones) are configured to only capture the energy of user speech. In other words, background noise may not be present or otherwise reflected in the auxiliary audio signals. Thus, aspects of the present disclosure recognize that the energy in the auxiliary audio signal may directly indicate a presence or absence of speech. For example, the VAD 305 may determine that speech is present in the audio signal X₀(l, k) (VAD(l)=1) if the energy of the auxiliary audio signal is greater than a threshold energy level.

A gain filter component 330 receives the target signal T(l, k) and the refined noise signal N(l, k) from the residual speech remover 320, e.g., after the noise signal N(l, k) is scaled and residual speech is removed. The gain filter component 330 determines the gain filter G(l, k) based on the target signal T(l, k) and the refined noise signal N(l, k), e.g., using spectral subtraction.

The gain filter G(l, k) and the target signal T(l, k) are received by the enhanced audio signal component 340, which applies the gain filter G(l, k) to the target signal T(l, k), e.g., as illustrated in equation 2, to obtain the enhanced audio signal Y(l, k).

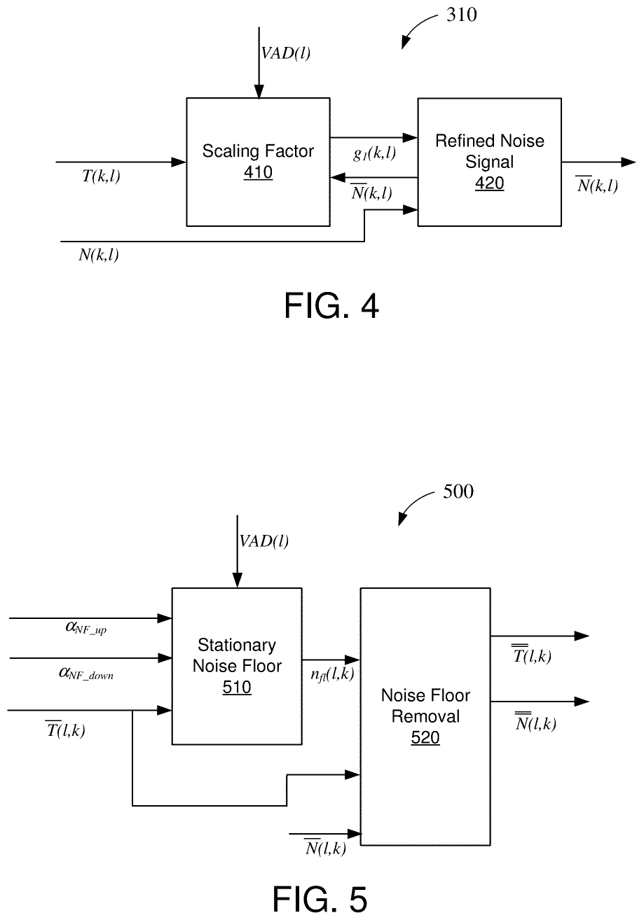

FIG. 4 shows a block diagram of an example of the noise signal scaler 310 that receives the target signal T(l, k) and the noise signal N(l, k) and refines the noise signal by scaling the noise signal N(l, k) when speech is not detected in the target signal T(l, k), e.g., as indicated by the speech detection signal (VAD(l)=0) from the VAD 305.

The noise signal scaler 310 may operate based on the premise that the magnitude of the target signal T(l, k) (denoted as |T|=T̅) is a slowly-evolving scalar (denoted as scaling factor g₁) multiplication of the magnitude of noise signal (denoted as |N|=N̅), such that when no speech is present (VAD(l)=0), the squared magnitude error on average, is minimized to suppress interference in the target signal T(l, k) using the gain filter G(l, k) determined by spectral subtraction. The squared magnitude error, for example, may be written as follows, where pₙₒᵢₛₑ(l, k) is the probability of noise at each time frequency, e.g., determined by the VAD 305 and included as a parameter in the speech detection signal VAD(l), and δ_{N} is the smoothed variance for the noise signal N̅.

$$\frac{{p}_{noise} ( l , k )}{{δ}_{N}} {\vert \overline{T} - {g}_{1} \overline{N} \vert}^{2} \qquad ( 4 )$$

Thus, the noise signal scaler 310 may include a scaling factor component 410 for determining the scaling factor g₁ and a refined noise signal component 420 to generate the refined noise signal N(l, k) based on the scaling factor g₁.

The scaling factor g₁ may be determined by the scaling factor component 410 based on a difference between the target signal T(l, k) and the refined noise signal N(l, k). For example, the scaling factor g₁ may be determined by minimizing the error signal e₁(l, k), e.g., the difference between the target signal T(l, k) and the scaled noise signal g₁N(l, k), which may be written as follows:

e₁(l,k)=T̅(l,k)−g₁(l,k)N̅(l,k). (5)

In some implementations, the scaling factor component 410 may determine the scaling factor g₁ using a normalized least mean squares (LMS) algorithm that operates in real-time. The normalized LMS algorithm may be set up as follows:

$${g}_{1} ( l + 1 , k ) = {g}_{1} ( l , k ) + \frac{μ {p}_{noise} ( l , k )}{{δ}_{N} ( l , k )} {e}_{1} ( l , k ) \overline{N} ( l , k ) . \qquad ( 6 )$$

Where δ_{N} is the smoothed variance for N̅, μ is a fixed step size close to zero, and pₙₒᵢₛₑ(l, k) is the probability of noise at each time frequency as determined by the VAD 305 and provided as a parameter in the speech detection signal VAD(l).

In some implementations, the scaling factor component 410 may determine the scaling factor g₁ using a recursive lease squares (RLS) algorithm that operates in real-time. The RLS algorithm may be set up as follows.

$${RLS}_{gain}^{n} ( l , k ) = \frac{{p}_{noise} ( l , k ) {φ}^{n} ( l - 1 , k ) \overline{N} ( l , k )}{γ {δ}_{N} ( l , k ) + {\overline{{p}_{noise} ( l , k ) N}}^{2} ( l , k ) {φ}^{n} ( l - 1 , k )} \qquad ( 7 )$$

$${g}_{1} ( l + 1 , k ) = {g}_{1} ( l , k ) + RL {S}_{gain}^{n} ( l , k ) \qquad ( 8 )$$

$${φ}^{n} ( l - 1 , k ) = \frac{1}{γ} ( {φ}^{n} ( l - 1 , k ) - {RLS}_{gain}^{n} ( l , k ) \overline{N} ( l , k ) {φ}^{n} ( l - 1 , k ) ) \qquad ( 9 )$$

Where γ is a forgetting factor that is close to 1.

In some implementations, the scaling factor component 410 may determine the scaling factor g₁ using a simplified update rule that does not rely on input signal N(l, k) as used in the LMS or RLS update. The simplified update rule, for example, may depend only on the error (from equation 5) and the scaling factor g₁ and a smoothed noise magnitude for the magnitude of the noise signal over time (Ñ(l, k)), and may be obtained as follows.

$${g}_{1} ( l + 1 , k ) = {g}_{1} ( l , k ) + \frac{μ {p}_{noise} ( l , k )}{\tilde{N} ( l , k )} {e}_{1} ( l , k ) \qquad ( 10 )$$

The determination of the smoothed variance for the magnitude of the noise signal over time (Ñ (l, k)) is illustrated by the pseudo-code in Table 1, where the increasing smoothing factor α_{Nup} is greater than the decreasing smoothing factor α_{Ndown}, and may be provided as parameters to the scaling factor component 410.

TABLE 1

```
if (VAD = 0)
  for k=0: max_bins
    if (N̅(k, l) > Ñ(k, l)
      α = α_{Nup};
    else
      α = α_{Ndown};
    end
    Ñ(l, k)= α * Ñ(l − 1, k) + (1 − α) * N̅(l, k);
  end
end
```

The refined noise signal component 420 receives the scaling factor g₁ from the scaling factor component 410 and refines the noise signal N(l, k) by generating and producing a scaled noise signal N̅(l, k) as follows.

N̅(l,k)←g₁(l,k)N̅(l,k) (11)

When speech is present in the target signal, e.g., VAD(l)=1, the noise signal N(l, k), may include some residual speech. Thus, determining the gain filter G(l, k) based on the scaled noise signal N̅(l, k), e.g., using spectral subtraction from the target signal T̅(l, k), may result in some speech attenuation in the target signal T̅(l, k) due to the residual speech in the noise signal N̅(l, k). Accordingly, the residual speech in the noise signal N̅(l, k) is removed during the refinement process.

In one implementation, it may be desirable to first remove a noise floor from the target signal \tilde{T}(l, k) and the noise signal N̅(l, k) so that only residual speech in the noise signal N̅(l, k) is removed in the refinement process.

FIG. 5 shows a block diagram of an example noise floor remover 500 that may be configured to remove a noise floor from the target signal T̅(l, k) and the noise signal N̅(l, k) using a smoothed stationary noise floor n_{fl}(l, k) determined based on target signal T̅(l, k) when speech is not detected. The noise floor remover 500, for example, may be included in or external to the residual speech remover 320 in the nonlinear post filter 300.

The noise floor remover 500 includes a stationary noise floor component 510 that receives the target signal T̅(l, k), and smoothing parameters α_{NF_up} and α_{NF_down} for smoothing the stationary noise floor when the noise floor is increasing or decreasing, respectively, where α_{NF_up}>α_{NF_down}, and are close to 1. The stationary noise floor component 510, for example, may determine a smoothed stationary noise floor n_{fl}(l, k) based on target signal T̅(l, k) when speech is not detected, e.g., as indicated by the speech detection signal (VAD(l)=0), as illustrated by the pseudo-code in Table 2.

TABLE 2

```
if (VAD == 0)
  for k=0: max_bins
    if (T̅(l, k) > n_{fl}(l, k))
      α = α_{N}_{_{—}}_{flup};
    else
      α = α_{N}_{_{—}}_{fldown};
    n_{fl}(l, k) = α * n_{fl}(l − 1, k) + (1 − α) * T̅(l, k);
    end
  end
end
```

The noise floor remover 500 includes a noise floor removal component 520 that receives the target signal T̅(l, k), the scaled noise signal N̅(l, k), and the stationary noise floor n_{fl}(l, k), and may remove the stationary noise floor n_{fl}(l, k) from the target signal T̅(l, k) and the scaled noise signal N̅(l, k), as follows.

N̅(l,k)=max(N̅(l,k)−n_{fl}(l,k),0) (12)

T̅(l,k)=max(T̅(l,k)−n_{fl}(l,k),0) (13)

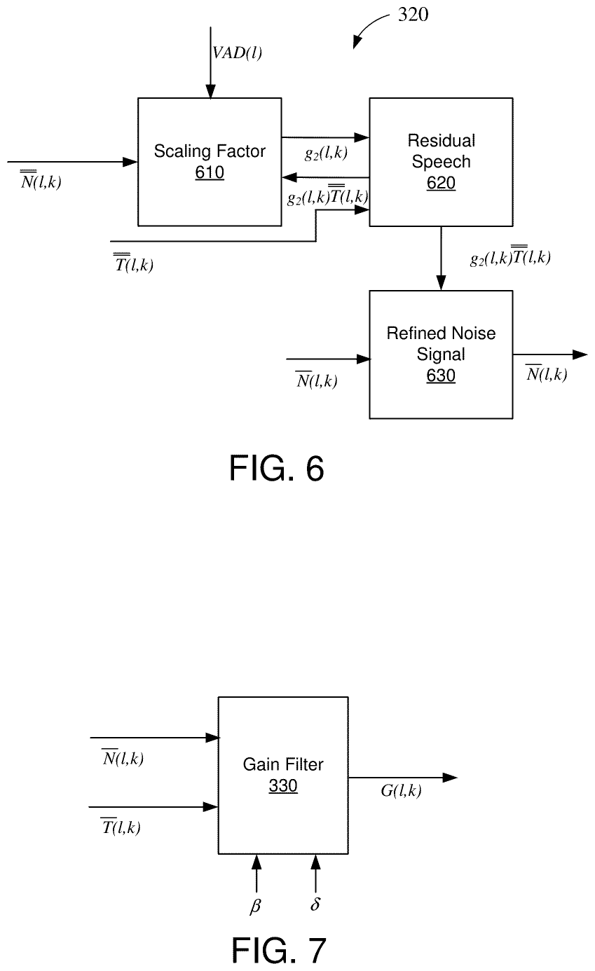

FIG. 6 shows a block diagram of an example residual speech remover 320 that receives the target signal and scaled noise signal, and further refines noise signal by removing any residual speech present in the scaled noise signal when speech is not detected in the target signal, e.g., as indicated by the VAD(l) parameter (VAD(l)=1) from the VAD 305. In some implementations, as illustrated in FIG. 6, the residual speech remover 320 may receive and operate on the target signal T̅(l, k) and scaled noise signal N̅(l, k) after removal of the noise floor, e.g., by the noise floor remover 500, shown in FIG. 5. In some implementations, the residual speech remover 320 may receive and similarly operate on the target signal T̅(l, k) and the scaled noise signal N̅(l, k) without the noise floor removal.

The residual speech remover 320 may operate based on the premise that the magnitude of the residual speech in the scaled noise signal N̅(l, k) is a scalar (denoted as scaling factor g₂) multiplication of the magnitude of target signal T̅(l, k) when speech is present (VAD(l)=1), and the squared magnitude error on average, is minimized. The squared magnitude error, for example, may be written as follows, where p_{speech}(l, k) is the probability of speech at each time frequency, e.g., determined by the VAD 305, and δ_{T} is the smoothed variance for the target signal T̅(l, k).

$$\frac{{p}_{speech} ( l , k )}{{δ}_{T}} {\vert \overline{\overline{N}} ( l , k ) - {g}_{2} \overline{\overline{T}} ( l , k ) \vert}^{2} \qquad ( 14 )$$

The residual speech in the noise signal is contained in g₂T̅, which may be subtracted from the scaled noise signal (N̅(l, k)) to obtain a refined noise signal, e.g., the scaled noise signal with the residual speech minimized.

Thus, the residual speech remover 320 may include a scaling factor component 610 for determining the scaling factor g₂ and a residual speech component 620 to generate the residual speech based on the scaling factor g₂ and the target signal T̅(l, k).

The scaling factor g₂ may be determined by the scaling factor component 610 based on a difference between the scaled noise signal N̅(l, k)) and the residual speech. For example, the scaling factor g₂ may be determined by minimizing the error signal e₂ (l, k), e.g., the difference between the scaled noise signal N̅(l, k)) and the residual speech contained in g₂T̅(l, k), which may be written as follows:

e₂(l,k)=N̅(l,k)−g₂(l,k)T̅(l,k). (15)

In some implementations, the scaling factor component 610 may determine the scaling factor g₂ using a normalized least mean squares (LMS) algorithm that operates in real-time. The normalized LMS algorithm may be set up as follows:

$${g}_{2} ( l + 1 , k ) = {g}_{2} ( l , k ) + \frac{μ {p}_{speech} ( l , k )}{{δ}_{T} ( l , k )} {e}_{1} ( k , l ) \overline{\overline{T}} ( l , k ) \qquad ( 16 )$$

Where δ_{T} is the smoothed variance for T̅ over time while speech is detected (VAD(l)=1), μ is a fixed step size close to zero, and p_{speech}(l, k) is the probability of speech at each time frequency as determined by the VAD 305 and provided as a parameter in the speech detection signal VAD(l).

In some implementations, the scaling factor component 610 may determine the scaling factor g₂ using a recursive lease squares (RLS) algorithm that operates in real-time. The RLS algorithm may be set up as follows:

$$R L {S}_{g a i n}^{s} ( l , k ) = \frac{{p}_{speech} ( l , k ) {φ}^{s} ( l - 1 , k ) \overline{\overline{T}} ( l , k )}{γ {δ}_{T} ( l , k ) + {p}_{speech} ( l , k ) {\overline{\overline{T}}}^{2} ( l , k ) {φ}^{s} ( l - 1 , k )} \qquad ( 17 )$$

$${g}_{2} ( l + 1 , k ) = {g}_{2} ( l , k ) + RL {S}_{gain}^{s} ( l , k ) {e}_{2} ( l , k ) \qquad ( 18 )$$

$${φ}^{s} ( l - 1 , k ) = \frac{1}{γ} ( {φ}^{s} ( l - 1 , k ) - a ( l , k ) \overline{\overline{T}} ( l , k ) {φ}^{s} ( l - 1 , k ) ) \qquad ( 19 )$$

Where γ is a forgetting factor that is close to 1.

In some implementations, the scaling factor component 610 may determine the scaling factor g₂ using a simplified update rule that does not rely on input signal T̅(l, k) as used in the LMS or RLS update. The simplified update rule, for example, may depend only on the error (from equation 15) and the scaling factor g₂ and a smoothed target magnitude for the magnitude of the target signal T̅ over time (\tilde{T}(l, k)) while speech is detected, and may be obtained as follows.

$${g}_{2} ( l + 1 , k ) = {g}_{2} ( l , k ) + \frac{μ}{\tilde{T} ( l , k )} {e}_{2} ( l , k ) \qquad ( 20 )$$

The residual speech component 620 receives the scaling factor g₂ from the scaling factor component 610 and target signal T̅(l, k) and generates and outputs the residual speech g₂T̅(l, k).

The residual speech remover 320 may include a refined noise signal component 630 that receives the scaled noise signal N̅(l, k), e.g., without the noise floor removed, and the residual speech g₂T̅(l, k) and, when speech is detected VAD(l)=1, generates a refined noise signal N(l, k) that is the scaled noise signal N(l, k) with residual speech removed as follows.

N̅(l,k)←max(N̅(l,k)−g₂(l+1,k)T̅(l,k),0) (21)

The removal of the residual speech from the scaled noise signal by the residual speech remover 320, including the determination of the smoothed variance \tilde{T}(l, k), is illustrated by the pseudo-code in Table 3, where the Ims_rate is a step size of the LMS algorithm and is tuned and set accordingly, and ε is a small value to avoid dividing by zero for numerical stability.

TABLE 3

```
if (VAD ==1)
  for k=0: max_bins
    T̅(l, k) = max(T̅(l, k) − n_{fl}(l, k), 0);
      if (T̅(l, k) > \tilde{T}(l, k)
        α = α_{Sup};
      else
        α = α_{Sdown};
      end
      \tilde{T}(l, k)= α * \tilde{T}(l − 1, k) + (1 − α) * T̅(l, k);
      N̅(l, k)= max(N̅(l, k) − n_{fl}(l, k), 0);
      Imserr = N̅(l, k) − g2(l, k)* T̅(l, k);
      μ = Ims_rate / (T̆(l, k)+ ε);
      g2(l, k) = g2(l − 1, k)+ μ * Imserr;
      g2(l, k)= max(g2(l, k), 0);
    N̅(l, k) = max(N̅(l, k)− g2(l, k)* T̅(l, k)), 0);
  end
end
```

The refined noise signal component 630 may additionally add the stationary noise floor back in if it was removed. The stationary noise floor may be added back in as follows.

N̅(l,k)←max(N̅(l,k),n_{fl}(l,k)) (22)

FIG. 7 shows a block diagram of an example gain filter component 330 that receives the target signal T̅(l, k) and the refined noise signal N̅(l, k), e.g., the scaled noise signal with the residual speech removed. The gain filter component 330 determines the gain filter G(l, k) based on the target signal T̅(l, k) and the refined noise signal N̅(l, k). For example, the gain filter component 330 may determine the gain filter G(l, k), for example, using spectral subtraction of the refined noise signal N̅(l, k) from the target signal T̅(l, k) as follows:

$$G ( k , l ) = max ( \frac{max ( \overline{T} ( l , k ) - β \overline{N} ( l , k ) , 0 )}{max ( \overline{T} ( l , k ) , ε )} , δ ) \qquad ( 23 )$$

Where ε is a small value to avoid division by zero, and β and δ are the spectral subtraction noise over-estimate parameter and noise minimum floor parameter, respectively, which may be also provided to the gain filter component 330. The gain filter component 330 may further smooth the gain filter G(l, k) in time domain and frequency domain, e.g., using Gamma-tone filter, to achieve the final gain filter G(l, k).

As discussed in FIG. 3, the enhanced audio signal component 340 receives the final gain filter G(l, k) and the target signal T(l, k) and generates the enhanced audio signal Y(l, k) as illustrated in equation 2.

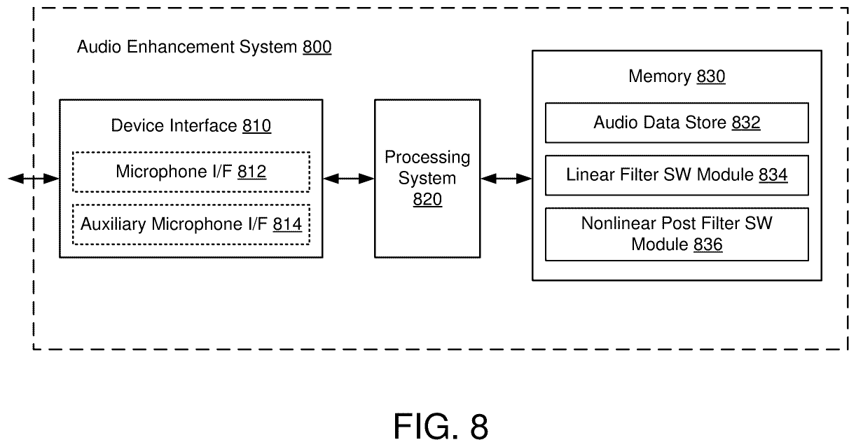

FIG. 8 shows another block diagram of an example audio enhancement system 800, according to some implementations. The audio enhancement system 800 is configured to enhance an audio signal by suppressing residual interference, such as noise and echoes, that remain in an audio signal after linear filtering, as discussed herein. The residual interference may be suppressed using a nonlinear post filter that operates on a target signal, which includes speech and residual interference, produced by the linear filter and a noise signal that that represents the interference that was removed from the raw microphone audio signal by the linear filter, as discussed herein. The raw microphone audio signal may be received via one or more microphones. In some implementations, an auxiliary audio signal may be received via an auxiliary microphone that is configured to only capture the energy of user speech. In some implementations, the one or more microphones may be microphones 110(0), 110(1), . . . 110(M−1) of FIG. 1 and the auxiliary microphone, if present, may be a bone conduction microphone.

The audio enhancement system 800 includes a device interface 810, a processing system 820, and a memory 830. The device interface 810 is configured to communicate with one or more components of an audio receiver (such as the audio receiver 100 of FIG. 1). In some implementations, the device interface 810 may include a microphone interface (I/F) 812 configured to communicate with the one or more microphones, which may be in a microphone array, and an auxiliary microphone interface (I/F) 814 configured to communicate with an auxiliary microphone, if present. The microphone interface 812 may receive a audio signals via the one or more microphones. The auxiliary microphone interface 814 may receive the auxiliary audio signal via the auxiliary microphone, if present.

The memory 830 may include an audio data store 832 configured to store frames of the audio signal and optionally the auxiliary audio signal, if present, as well as any intermediate signals that may be produced by the audio enhancement system 800 as a result of audio enhancement. The memory 830 also may include a non-transitory computer-readable medium (including one or more nonvolatile memory elements, such as EPROM, EEPROM, Flash memory, or a hard drive, among other examples) that may store at least the following software (SW) modules:
a linear filter SW module 834 to linearly filter the audio signal received via the microphone interface 812 to produce a target signal that includes desired speech and residual interference, such as noise or echoes, that is not removed from the audio signal by the linear filter, and a noise signal that contains the interference component, e.g., noise or echoes, that is removed from the audio signal by the linear filter; and
a nonlinear post filter SW module 836 to nonlinearly filter the target signal based on the target signal and the noise signal by refining the noise signal to scale the noise signal and remove any residual speech in the noise signal before generating a gain filter that is applied to target signal to produce an enhanced audio signal with the residual interference suppressed.

Each software module includes instructions that, when executed by the processing system 820, causes the audio enhancement system 800 to perform the corresponding functions.

The processing system 820 may include any suitable one or more processors capable of executing scripts or instructions of one or more software programs stored in the audio enhancement system 800 (such as in the memory 830). For example, the processing system 820 may execute the linear filter SW module 834 to linearly filter the audio signal received via the microphone interface 812 to produce a target signal that includes desired speech and residual interference, such as noise or echoes, that is not removed from the audio signal by the linear filter, and a noise signal that contains the interference component, e.g., noise or echoes, that is removed from the audio signal by the linear filter. The processing system 820 also may execute the nonlinear post filter SW module 836 to nonlinearly filter the target signal based on the target signal and the noise signal by refining the noise signal to scale the noise signal and remove any residual speech in the noise signal before generating a gain filter that is applied to target signal to produce an enhanced audio signal with the residual interference suppressed.

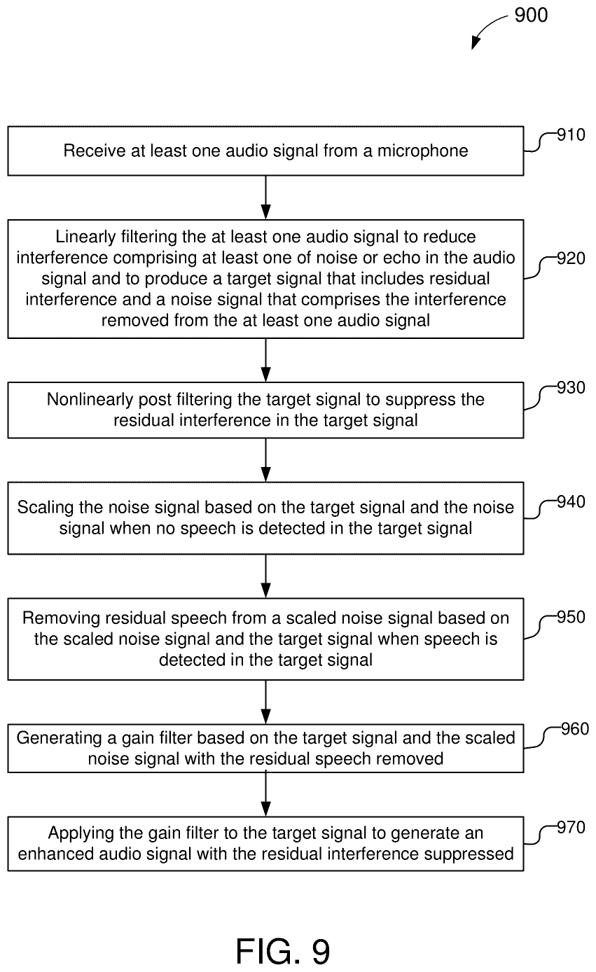

FIG. 9 shows an illustrative flowchart depicting an example operation 900 for audio interference reduction, according to some implementations. In some implementations, the example operation 900 may be performed by an audio enhancement system such as the audio receiver 100 of FIG. 1, the linear filter 200 and the nonlinear post filter 300 of FIGS. 2 and 3, respectively, or the audio enhancement system 800 of FIG. 8.

The audio enhancement system receives at least one audio signal from a microphone (910), e.g., as illustrated by audio signals Xᵢ(l, k), i=0 . . . . M−1, M≥1, from microphones 110(0), 110(1), . . . 110(M−1) received by the linear filter 130 and 200 shown in FIGS. 1 and 2, respectively. In some implementations, the at least one audio signal may include a plurality of audio signals received from a plurality of microphones, respectively, of a microphone array.

The audio enhancement system linearly filtering the at least one audio signal to reduce interference comprising at least one of noise or echo in the audio signal and to produce a target signal that includes residual interference and a noise signal that comprises the interference removed from the at least one audio signal (920), e.g., as illustrated by the linear filter 130 and 200 shown in FIGS. 1 and 2, respectively. In some implementations, linearly filtering the at least one audio signal includes spatially filtering the at least one audio signal by beamforming, and the residual interference in the target signal includes noise. In some implementations, linearly filtering the at least one audio signal includes echo cancellation in the at least one audio signal, and the residual interference in the target signal includes echoes.

The audio enhancement system nonlinearly post filters the target signal to suppress the residual interference in the target signal (930), e.g., as illustrated by the nonlinear post filter 140 and 300 shown in FIGS. 1 and 2, respectively. Nonlinearly post filtering the target signal includes the following.

The audio enhancement system scales the noise signal based on the target signal and the noise signal when no speech is detected in the target signal (940), e.g., as illustrated by the noise signal scaler 310 in FIGS. 3 and 4.

The audio enhancement system removes residual speech from a scaled noise signal based on the scaled noise signal and the target signal when speech is detected in the target signal (950), e.g., as illustrated by the residual speech remover 320 in FIGS. 3 and 6.

The audio enhancement system generates a gain filter based on the target signal and the scaled noise signal with the residual speech removed (960), e.g., as illustrated by the gain filter component 330 in FIGS. 3 and 7.

The audio enhancement system applies the gain filter to the target signal to generate an enhanced audio signal with the residual interference suppressed (970), e.g., as illustrated by the enhanced audio signal component 340 in FIG. 3.

In some implementations, the noise signal is produced based on a comparison of the target signal and the at least one audio signal from the microphone, e.g., as illustrated by the noise signal generator 220 shown in FIG. 2.

In some implementations, the audio enhancement system is configured to scale the noise signal by determining a scaling factor based on a difference between the target signal and the scaled noise signal when no speech is detected in the target signal, e.g., as illustrated by the scaling factor component 410 shown in FIG. 4, and applying the scaling factor to the noise signal to produce the scaled noise signal, e.g., as illustrated by the refined noise signal component 420 shown in FIG. 4.

In some implementations, the audio enhancement system is configured to remove the residual speech from the scaled noise signal by determining a scaling factor based on a difference between the scaled noise signal and residual speech in the noise signal when speech is detected in the target signal, e.g., as illustrated by the scaling factor component 610 shown in FIG. 6. The audio enhancement system is further configured to apply the scaling factor to the target signal to produce the residual speech in the noise signal, e.g., as illustrated by the residual speech component 620 shown in FIG. 6. The audio enhancement system is further configured to subtract the residual speech in the noise signal from the scaled noise signal to remove the residual speech from the scaled noise signal, e.g., as illustrated by the refined noise signal component 630 shown in FIG. 6.

Additionally, in some implementations, the audio enhancement system may be configured to determine a noise floor for the target signal when no speech is detected in the target signal, e.g., as illustrated by the stationary noise floor component 510 shown in FIG. 5. The audio enhancement system may be further configured to remove the noise floor from the scaled noise signal and the target signal before determining the scaling factor based on the difference between the scaled noise signal and the residual speech in the noise signal when speech is detected in the target signal, e.g., as illustrated by the noise floor removal component 520 shown in FIG. 5. The noise floor may be used as the scaled noise signal with the residual speech removed when the noise floor is greater than the scaled noise signal with the residual speech removed.

In some implementations, the audio enhancement system is configured to generate the gain filter based on the target signal and the scaled noise signal with the residual speech removed by performing spectral subtraction of the target signal and the scaled noise signal with the residual speech removed, e.g., as illustrated by the gain filter component 330 shown in FIGS. 3 and 7.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for enhanced interference reduction in an audio signal, comprising:
receiving at least one audio signal from a microphone;
linearly filtering the at least one audio signal to reduce interference comprising at least one of noise or echo in the audio signal and to produce a target signal that includes residual interference and a noise signal that comprises the interference removed from the at least one audio signal; and
nonlinearly post filtering the target signal to suppress the residual interference in the target signal, wherein nonlinearly post filtering the target signal comprises:
scaling the noise signal based on the target signal and the noise signal when no speech is detected in the target signal;
removing residual speech from a scaled noise signal based on the scaled noise signal and the target signal when speech is detected in the target signal;
generating a gain filter based on the target signal and the scaled noise signal with the residual speech removed; and
applying the gain filter to the target signal to generate an enhanced audio signal with the residual interference suppressed.

2. The method of claim 1, wherein the at least one audio signal comprises a plurality of audio signals received from a plurality of microphones, respectively, of a microphone array.

3. The method of claim 1, wherein linearly filtering the at least one audio signal comprises spatially filtering the at least one audio signal by beamforming, wherein the residual interference in the target signal comprises noise.

4. The method of claim 1, wherein linearly filtering the at least one audio signal comprises echo cancellation in the at least one audio signal, wherein the residual interference in target signal comprises echoes.

5. The method of claim 1, wherein the noise signal is produced based on a comparison of the target signal and the at least one audio signal from the microphone.

6. The method of claim 1, wherein scaling the noise signal comprises:
determining a scaling factor based on a difference between the target signal and the scaled noise signal when no speech is detected in the target signal; and
applying the scaling factor to the noise signal to produce the scaled noise signal.

7. The method of claim 1, wherein removing the residual speech from the scaled noise signal comprises:
determining a scaling factor based on a difference between the scaled noise signal and residual speech in the noise signal when speech is detected in the target signal;
applying the scaling factor to the target signal to produce the residual speech in the noise signal; and
subtracting the residual speech in the noise signal from the scaled noise signal to remove the residual speech from the scaled noise signal.

8. The method of claim 7, further comprising:
determining a noise floor for the target signal when no speech is detected in the target signal;
removing the noise floor from the scaled noise signal and the target signal before determining the scaling factor based on the difference between the scaled noise signal and the residual speech in the noise signal when speech is detected in the target signal; and
using the noise floor as the scaled noise signal with the residual speech removed when the noise floor is greater than the scaled noise signal with the residual speech removed.

9. The method of claim 1, wherein generating the gain filter based on the target signal and the scaled noise signal with the residual speech removed comprises performing spectral subtraction of the target signal and the scaled noise signal with the residual speech removed.

10. An audio enhancement system configured for enhancing interference reduction in an audio signal, comprising:
a processing system; and
a memory storing instructions that, when executed by the processing system, causes the audio enhancement system to:
receive at least one audio signal from a microphone;
linearly filter the at least one audio signal to reduce interference comprising at least one of noise or echo in the audio signal and to produce a target signal that includes residual interference and a noise signal that comprises the interference removed from the at least one audio signal; and
nonlinearly post filter the target signal to suppress the residual interference in the target signal, wherein the audio enhancement system is configured to nonlinearly post filter the target signal by being configured to:
scale the noise signal based on the target signal and the noise signal when no speech is detected in the target signal;
remove residual speech from a scaled noise signal based on the scaled noise signal and the target signal when speech is detected in the target signal;
generate a gain filter based on the target signal and the scaled noise signal with the residual speech removed; and
apply the gain filter to the target signal to generate an enhanced audio signal with the residual interference suppressed.

11. The audio enhancement system of claim 10, wherein the at least one audio signal comprises a plurality of audio signals received from a plurality of microphones, respectively, of a microphone array.

12. The audio enhancement system of claim 10, wherein linearly filtering the at least one audio signal comprises spatially filtering the at least one audio signal by beamforming, wherein the residual interference in the target signal comprises noise.

13. The audio enhancement system of claim 10, wherein linearly filtering the at least one audio signal comprises echo cancellation in the at least one audio signal, wherein the residual interference in the target signal comprises echoes.

14. The audio enhancement system of claim 10, wherein the noise signal is produced based on a comparison of the target signal and the at least one audio signal from the microphone.

15. The audio enhancement system of claim 10, wherein the audio enhancement system is configured to scale the noise signal by being configured to:
determine a scaling factor based on a difference between the target signal and the scaled noise signal when no speech is detected in the target signal; and
apply the scaling factor to the noise signal to produce the scaled noise signal.

16. The audio enhancement system of claim 10, wherein the audio enhancement system is configured to remove the residual speech from the scaled noise signal by being configured to:
determine a scaling factor based on a difference between the scaled noise signal and residual speech in the noise signal when speech is detected in the target signal;
apply the scaling factor to the target signal to produce the residual speech in the noise signal; and
subtract the residual speech in the noise signal from the scaled noise signal to remove the residual speech from the scaled noise signal.

17. The audio enhancement system of claim 16, wherein the audio enhancement system is further configured to:
determine a noise floor for the target signal when no speech is detected in the target signal;
remove the noise floor from the scaled noise signal and the target signal before determining the scaling factor based on the difference between the scaled noise signal and the residual speech in the noise signal when speech is detected in the target signal; and
use the noise floor as the scaled noise signal with the residual speech removed when the noise floor is greater than the scaled noise signal with the residual speech removed.

18. The audio enhancement system of claim 10, wherein configured to generate the gain filter based on the target signal and the scaled noise signal with the residual speech removed by being configured to perform spectral subtraction of the target signal and the scaled noise signal with the residual speech removed.
